(19) United States
(12) Patent Application Publication
(10) Pub. No.: US 2010/0002459 A1
(43) Pub. Date: Jan. 7, 2010

(54) COVER FOR REDUCING LIGHT AND HEAT RECEIVED ON VEHICLE'S SURFACE

(76) Inventor: Michael Lusk, Naples, FL (US)

Correspondence Address: JAY M. SCHLOFF, 6960 Orchard Lake Road, Suite 315, West Bloomfield, MI, 48322, US

(21) Appl. No.: 12/496,118

(22) Filed: Jul. 1, 2009

Related U.S. Application Data
(60) Provisional application No. 61/078,003, filed on Jul. 3, 2008.

(51) Int. Cl. F21V 7/00

(52) U.S. Cl. 362/517

(57) ABSTRACT

Disclosed is a cover for reducing light and heat received on an interior surface of a vehicle. The cover includes a plurality of reflecting elements and a plurality of light absorbing elements. Each reflecting element of the plurality of reflecting elements is inclined at a predefined inclination with respect to the interior surface. The predefined inclination enables the each reflecting element to reflect the light and the heat received on the interior surface. The plurality of light absorbing elements is coupled with the plurality of reflecting elements to form a saw-tooth arrangement. The plurality of light absorbing elements is capable of absorbing the light. Reflection of the light and the heat by the plurality of reflecting elements and absorption of the light by the plurality of light absorbing elements reduce the light and the heat received on the interior surface.

### CROSS REFERENCE TO RELATED APPLICATIONS

The present disclosure claims priority under 35 United States Code, Section 119 on the U.S. Provisional Patent Application No. 61/078,003 filed on Jul. 3, 2008, the disclosure of which is incorporated by reference.

### FIELD OF THE DISCLOSURE

The present disclosure relates generally to covers, and, more particularly, to a cover for reducing light and heat received from a source on a surface of a vehicle.

### BACKGROUND OF THE DISCLOSURE

Typically, in a vehicle, such as a car, a boat, an airplane, and the like, a driver is seated in a driver's seat and faces a windshield through which the driver views a route to be traversed. Generally, the vehicle includes an interior surface between the windshield and the driver which may include various instrument panels. The instrument panels may provide the driver various instrument readings, such as speed of the vehicle and quantity of fuel in the vehicle. The interior surface may also include an air-conditioning outlet that may blow hot or cold air in the vehicle. Further, the interior surface of the vehicle may also include storage space for keeping various articles, such as vehicle tools, documents of the vehicle, and the like. Specifically, the interior surface may be positioned near the windshield, so that the interior surface may be in a field-of-sight of the driver while he is driving the vehicle.

Sometimes, the driver, such as a pilot in case of an airplane, may need to touch the instrument panels to adjust certain settings, such as cabin pressure. Further, a driver of a car may need to adjust the air-conditioning outlet for redirecting flow of air in the vehicle. Furthermore, a driver or passenger may touch the interior surface of the vehicle while retrieving an article, such as a vehicle tool, from the storage space of the interior surface.

However, the interior surface of the vehicle, due to its proximity to the windshield, receives a significant amount of light and heat that falls on the windshield from a source, such as the sun. This causes heating of the interior surface of the vehicle. The problem is more severe in warm weather conditions when a considerable amount of heat is received on the interior surface of the vehicle, and heats up the interior surface. The heated interior surface can cause the passenger of the vehicle to accidentally burn his/her hand upon touching the interior surface. Further, the temperature inside the vehicle may increase due to heating of the interior surface, causing discomfort to passengers of the vehicle. Such temperature increase may also occur while a vehicle is parked or otherwise in a stationary position and is subjected to such light and heat.

Furthermore, the air conditioning outlet of the vehicle may get heated up and the air blown into the vehicle may be warmer than is preferred, causing an air conditioner of the vehicle to be less effective. Still further, the light received by the interior surface may produce a glare that may cause discomfort to the passenger, such as the driver, in viewing the route and in operating the vehicle, creating potential situations for a mishap to occur.

Currently, a few solutions exist for addressing these problems. The windshield may be covered with a sheet of dark and opaque material. The sheet may restrict entry of the light and the heat into the vehicle. As the entry of the light and the heat falling on the windshield is restricted, the amount of the light and the heat falling on the interior surface may be reduced. Further, to avoid the glare that falls into the eyes of the driver, the interior surface may be made of a dull color, such that the interior surface is unable to reflect the light.

However, the dull color of the interior surface may retain the heat that is received on the interior surface, thereby causing the interior surface and an interior of the vehicle to become hot. Further, the sheet may be used to cover the windshield when the vehicle is not in use. However, the sheet would obstruct a view of the driver while the vehicle is in motion, and thereby may not prevent the heat and the light from entering the moving vehicle.

In light of the drawbacks mentioned above, there is a need for reducing light and heat received on an interior surface of a vehicle. Further, there is a need to reduce heating of an interior surface of a vehicle. Furthermore, there is a need to reduce heating of an interior of a vehicle.

### SUMMARY OF THE DISCLOSURE

In view of the foregoing disadvantages inherent in the prior art, the general purpose of the present disclosure is to provide a cover for reducing light and heat received on an interior surface of a vehicle, configured to include all the advantages of the prior art, and to overcome the drawbacks inherent therein.

Accordingly, an object of the present disclosure is to provide a cover capable of reducing light and heat received on an interior surface of a vehicle.

Another object of the present disclosure is to provide a cover capable of reducing heating of an interior surface of a vehicle.

Yet another object of the present disclosure is to provide a cover capable of reducing heating of an interior of a vehicle.

In light of the above objects, in one aspect of the present disclosure, a cover for reducing light and heat received on an interior surface of a vehicle is provided. The cover includes a plurality of reflecting elements and a plurality of light absorbing elements. Each reflecting element of the plurality of reflecting elements is inclined at a predefined inclination with respect to the interior surface. The predefined inclination enables the each reflecting element to reflect the light and the heat received on the interior surface. The plurality of light absorbing elements is coupled with the plurality of reflecting elements to form a saw-tooth arrangement. The plurality of light absorbing elements is capable of absorbing the light. Reflection of the light and the heat by the plurality of reflecting elements and absorption of the light by the light absorbing elements reduce the light and the heat received on the interior surface.

This together with other aspects of the present disclosure, along with the various features of novelty that characterize the present disclosure, are pointed out with particularity in the claims annexed hereto and form a part of this present disclosure. For a better understanding of the present disclosure, its operating advantages, and the specific objects attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates a side view of an environment of an exemplary vehicle in which the present disclosure may be practiced.

FIG. 2 illustrates a side view of a cover for reflecting light and heat received on an interior surface of a vehicle, in accordance with an embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in composition, structure, and design. It should be emphasized, however, that the present disclosure is not limited to a particular cover for reducing light and heat received on an interior surface of a vehicle, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “a” and “an” herein do not denote a limitation of quantity, but rather denote the presence of at least one of the referenced items.

The present disclosure provides a cover for reducing light and heat received on an interior surface of a vehicle. Examples of the vehicle may include a car, a boat, an airplane, a spacecraft, and the like. An example of the interior surface of the vehicle is a dashboard of a car. The cover of the present disclosure includes a plurality of reflecting elements and a plurality of light absorbing elements. The plurality of light absorbing elements is coupled with the plurality of reflecting elements to form a saw-tooth arrangement. The plurality of reflecting elements is capable of reflecting the light and the heat received on the interior surface. The plurality of light absorbing elements is capable of absorbing the light received on the interior surface. Reflection of the light and the heat by the plurality of reflecting elements and absorption of the light by the light absorbing elements reduce the light and the heat received on the interior surface.

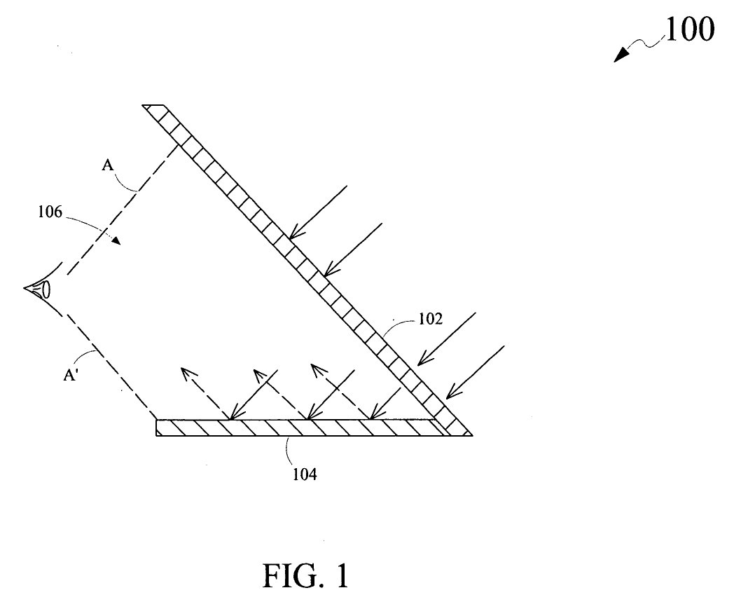

FIG. 1 illustrates a side view of an environment 100 of an exemplary vehicle (not numbered) in which the present disclosure may be practiced. Examples of the vehicle may include a car, a boat, an airplane, a spacecraft, and the like. The environment 100 includes an entry surface 102 and an interior surface 104.

For the purpose of description of the present disclosure, the entry surface 102 may be defined as a surface through which the light and the heat enter the vehicle. Examples of the entry surface 102 may include a windshield, a window, and the like. The entry surface 102 may be made up of glass material, plastic material such as Perspex, and the like. The interior surface 104 may be defined as a surface within the vehicle on which the light and the heat are received. Examples of the interior surface 104 may include a dashboard, an instrument panel, an arm rest, and the like. It will be evident to a person skilled in the art that the heat and the light originate from a radiation. The radiation may be emitted from a source, such as the sun, halogen lamps, incandescent lamps, and the like. The radiation emitted by the sun may include a light component and a heat component. The light component illuminates a surface, such as the interior surface 104, when the radiation falls on the surface. The heat component of the radiation includes infra-red rays that cause heating of the surface when the radiation falls on the surface. Further, the person skilled in the art may also appreciate that the radiation from a halogen lamp may also include a light component and a heat component. However, the heat component of the radiation emitted by the halogen lamp may be much lower as compared to the heat component of the radiation from the sun. For the purpose of this description, the light component of the radiation will be referred to as ‘light’ and the heat component of the radiation will be referred to as ‘heat’.

The light and the heat (not shown) are received on the entry surface 102 of the vehicle. The light received on the entry surface 102 is depicted by arrows. The entry surface 102 is coupled to the interior surface 104. The entry surface 102 transfers the light and the heat received to the interior surface 104. The light transferred to the interior surface 104 is depicted by the arrows. The interior surface 104 gets heated up when the heat (not shown) is received on the interior surface 104. Further, the heat may get reflected from the interior surface 104 towards an interior portion of the vehicle.

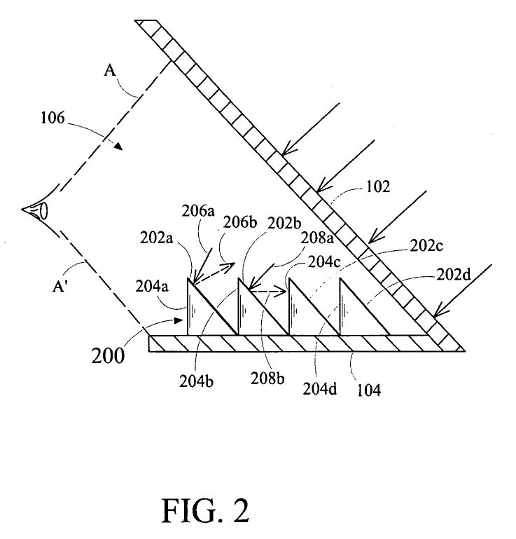

Furthermore, a portion of the light received by the interior surface 104 may get reflected towards a field of vision 106 of a driver of the vehicle. The field of vision 106 is enclosed between a line segment A, and a line segment A′. FIGS. 1 and 2 depict a two-dimensional view of the field of vision 106. However, it will be evident that the field of vision of humans is a three-dimensional space. Further, the field of vision 106 is an exemplary field of vision of the driver and may not be limited to an angular separation between the line segment A and the line segment A′ as depicted in FIGS. 1 and 2.

The portion of light reflected by the interior surface 104 towards the field of vision 106 of the driver is depicted with dotted arrows in FIG. 1.

It may be apparent to a person skilled in the art that the interior surface 104 may assume various shapes other than the shape depicted in FIG. 1. Further, it may be apparent to a person skilled in the art that the entry surface 102 may assume various shapes other than the shape depicted in FIG. 1. Furthermore, it may be apparent to a person skilled in the art that an inclination of the entry surface 102 with respect to the interior surface 104 is not limited to the depiction in FIG. 1, but may vary according to an aerodynamic structure of the vehicle.

FIG. 2 illustrates a side view of a cover 200 (placed on the interior surface 104 of the vehicle of FIG. 1), in accordance with an embodiment of the present disclosure. The cover 200 includes a plurality of reflecting elements, such as a reflecting element 202a, a reflecting element 202b, a reflecting element 202c and a reflecting element 202d, and a plurality of light absorbing elements, such as a light absorbing element 204a, a light absorbing element 204b, a light absorbing element 204c and a light absorbing element 204d. Hereinafter, the plurality of reflecting elements will be referred to as ‘plurality of reflecting elements 202’ and the plurality of light absorbing elements will be referred to as ‘plurality of light absorbing elements 204’.

The plurality of light absorbing elements 204 is coupled to the plurality of reflecting elements 202 to form a saw-tooth arrangement. Each reflecting element, such as the reflecting element 202a, is inclined at a predefined inclination with respect to the interior surface 104. The predefined inclination enables the each reflecting element to reflect the light and the heat received on the interior surface 104 of the vehicle. In an embodiment of the present disclosure, the plurality of light absorbing elements 204 may be perpendicular to the interior surface 104 of the vehicle. Further, the plurality of reflecting elements 202 may be inclined at an angle of 45 degrees with respect to the interior surface 104 of the vehicle. In another embodiment of the present disclosure, the cover 200 is composed of a flexible material that enables the cover 200 to be stretched. The cover 200 may be stretched to incline the plurality of reflecting elements 202 at a desired inclination based on the user's requirement.

Reflection of the light and the heat by the plurality of reflecting elements 202 and absorption of the light by the plurality of light absorbing elements 204 reduce the light and the heat received on the interior surface 104. Specifically, reflection of the light by the plurality of reflecting elements 202 reduces the glare effect caused by the light. Further, reflection of the heat by the plurality of reflecting elements 202 reduces heating of the interior surface 104 of the vehicle. Furthermore, the reflection of the heat reduces heating up of an interior, such as a cockpit, of the vehicle.

FIG. 2 depicts the light that is received on the entry surface 102 by arrows. The heat received on the entry surface 102 has not been depicted in FIG. 2. The entry surface 102 transfers the light and the heat towards the interior surface 104. In an embodiment of the present disclosure, the interior surface 104 is a dashboard of the vehicle. The cover 200 is placed on the interior surface 104. Accordingly, the light and the heat are received on the plurality of reflecting elements 202, such as the reflecting element 202a and the reflecting element 202b. The plurality of reflecting elements 202 is capable of reflecting the light and the heat. For instance, a ray of light 206a is reflected back towards the entry surface 102, as depicted by a reflected ray of light 206b. In another instance the light, such as a ray of light 208a is reflected in a direction as depicted by a reflected ray of light 208b. In an embodiment of the present disclosure, the plurality of reflecting elements 202 is made from at least one of a foil, a cardboard and a plastic material. It will be evident to a person skilled in the art that the heat may be reflected by the plurality of reflecting elements 202 in a manner similar to the reflection of the light from the plurality of reflecting elements 202.

Further, the plurality of light absorbing elements 204, such as the light absorbing element 204a, the light absorbing element 204b and the light absorbing element 204c are capable of absorbing the light reflected by the plurality of reflecting elements 202. For example, the ray of light 208a is received at the reflecting element 202b and is reflected as the reflected ray of light 208b. The reflected ray of light 208b may be absorbed by the light absorbing element 204c.

The plurality of light absorbing elements 204 may be made of a light absorbing material. Further, the plurality of light absorbing elements 204 may be arranged to face the driver of the vehicle. In an embodiment of the present disclosure, the plurality of light absorbing elements 204 may be positioned perpendicular to the interior surface 104 of the vehicle. As mentioned earlier, the plurality of reflecting elements 202 and the plurality of light absorbing elements 204 form a saw-tooth arrangement, as depicted in FIG. 2. However, it will be apparent to a person skilled in the art that the saw-tooth arrangement may differ from the arrangement shown in FIG. 2. In another embodiment of the present disclosure, a height of the each light absorbing element of the plurality of light absorbing elements 204 is in a range of about 0.25 inches. It will be apparent to a person skilled in the art that the given height of the plurality of light absorbing elements 204 does not limit the scope of the present disclosure, and the plurality of light absorbing elements 204 may be configured with varying heights. Further, it will be apparent to a person skilled in the art that the plurality of reflecting elements 202 may be composed of materials that are commonly known in the art, such as materials used in reflective car shields.

As explained previously, the interior surface 104 of the vehicle may assume various shapes other than the shape shown in FIG. 1. In an embodiment of the present disclosure, the cover 200 may be flexible and may be configured to attain a shape of the interior surface 104. The cover 200 may include a base (not shown) that is made of a flexible material. The base may be affixed to the plurality of reflective elements 202 and the plurality of light absorbing elements 204. The base may attain a shape of the interior surface 104.

A cover, such as the cover 200, capable of reducing light and heat received on an interior surface, such as the interior surface 104, of a vehicle is advantageous for reducing heating of the interior surface of the vehicle. Specifically, a plurality of reflecting elements, such as the plurality of reflecting elements 202 of the cover 200, are capable of reflecting a portion of the light and a portion of the heat, away from an interior of the vehicle. The reflection of the heat reduces heating up of the interior of the vehicle, thereby reducing discomfort to passengers traveling in the vehicle. Further, reflection of the heat also makes air conditioning of the vehicle more efficient.

Furthermore, the reflection of the light by the reflecting elements reduces a glare. Still further, a plurality of light absorbing elements, such as the plurality of light absorbing elements 204 of the cover 200 absorb the light that is reflected by the plurality of reflecting elements. Accordingly, absorption of the light by the light absorbing elements further reduces the glare, thereby reducing discomfort to a driver of the vehicle. Yet further, the cover prevents the interior surface from getting heated up, thereby precluding risk of injury, such as injury from a burn, to the passengers in the vehicle.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A cover for reducing light and heat received on an interior surface of a vehicle, the cover comprising:
a plurality of reflecting elements, each reflecting element of the plurality of reflecting elements inclined at a predefined inclination with respect to the interior surface, the predefined inclination enabling the each reflecting element to reflect the light and the heat received on the interior surface; and
a plurality of light absorbing elements coupled with the plurality of reflecting elements to form a saw-tooth arrangement, the plurality of light absorbing elements capable of absorbing the light,
wherein reflection of the light and the heat by the plurality of reflecting elements and absorption of the light by the light absorbing elements reduce the light and the heat received on the interior surface.

2. The cover of claim 1, wherein each light absorbing element of the plurality of light absorbing elements is positioned perpendicular with respect to the interior surface.

3. The cover of claim 1, wherein the interior surface is a dashboard.

4. The cover of claim 1, wherein the each reflecting element is made from at least one of a foil, a cardboard and a plastic material.

5. The cover of claim 1, wherein the cover is capable of attaining a shape of the interior surface.

6. The cover of claim 1, wherein a height of the each light absorbing element is in a range of about 0.25 inches.
